(19) United States
(12) Patent Application Publication
(10) Pub. No.: US 2022/0389176 A1
(43) Pub. Date: Dec. 8, 2022

(54) MOULDED ARTICLE

(71) Applicant: Zeroplast Sp. z.o o., Warschau (PL)

(72) Inventors: Andreas Adolf HUBER, Warschau (PL); Markus Josef HUBER, Warschau (PL); Claus STEFANSKI, Wien (AT); Friedrich BREIDENBACH, Wien (AT)

(73) Assignee: Zeroplast Sp. z.o o., Warschau (PL)

(21) Appl. No.: 17/767,073

(22) PCT Filed: Oct. 8, 2020
(86) PCT No.: PCT/EP2020/078211

§ 371 Date: Apr. 7, 2022

(30) Foreign Application Priority Data
Oct. 9, 2019 (AT) A50859/2019

(51) Int. Cl. C08J 5/04

(52) U.S. Cl. CPC C08J 5/046; C08J 5/045; C08J 2391/06

(57) ABSTRACT

The invention relates to a moulded article (3) comprising a basic material (1), wherein the basic material (1) contains a wax, and also a filler, wherein the filler comprises or consists of a mineral filler and/or a fibrous material, wherein the wax is contained in the basic material (1) with a content of between 3% by weight and 60% by weight, wherein the filler is contained in the basic material (1) with a content of between 40% by weight and 97% by weight, wherein the moulded article (3) comprises a moulded element (2), and wherein the moulded element (2) comprises or consists of a fibrous material. The invention also relates to a process for producing a moulded article (3).

The present invention relates to a molded article, in particular a container, comprising a base material, which contains wax and a filler mixture. The invention further relates to a method for producing a molded article.

Packaging materials are used in many areas, for example in the food industry or in the cosmetics industry. Packaging materials, in particular containers, are often made of plastics, ceramic materials or glass.

Among these, plastic has the disadvantage that often no renewable raw materials are used for production and thus products from the petroleum industry are used, which have a negative impact on the greenhouse gas balance.

Between the years 1950 and 2015, around 8.3 billion tons of plastic were produced worldwide—almost half of it since 2000. By 2025, more than 600 million tons of plastic are expected to be produced annually. The increasing demand for plastic inevitably leads to disposal issues and environmental problems, especially because current estimates suggest that about 40% of plastic products are waste after less than a month.

Other examples of frequently used packaging materials, in particular for containers of various kinds, are glass and ceramics. The processing of these materials is energy-consuming and costly. In particular, the melting of the starting materials for the production of glass containers and the sintering of ceramic materials are carried out at high temperatures, which requires a high energy input.

As an alternative to the aforementioned conventional materials, the state of the art proposes containers made of thermoplastic molding materials, which comprise wax and a filler. Such materials are known from AT 516 548 A1, for example. These materials have the advantage that due to the comparably low melting point of wax, a low energy input is needed for producing molded articles. Additionally, said wax-based materials can be produced optionally completely from renewable raw materials and are 100% recyclable.

In addition, raw materials that are non-toxic and can be produced without competing with agricultural products can be used to manufacture these materials. Such molding materials are additionally rapidly degradable in nature, and since no plastics (polymers) are included, no microplastics, which are considered highly problematic for the environment, can be formed when they enter the environment.

However, it has been found that molded articles, in particular containers, made entirely of such wax-based molding materials have disadvantages for certain applications. Examples of disadvantages can be:
insufficient impact toughness at low material thicknesses,
high weight due to the high filler content,
insufficient coatability due to hydrophobic surface,
insufficiently standardizable surface, in particular when natural materials are used,
lack of blowability of the molding material.

Thus, one object of the present invention can be seen in overcoming, at least in part, these disadvantages of the prior art and in providing an improved molded article, as well as a method for producing an improved molded article.

The invention relates to a molded article, comprising a base material, the base material containing a wax and a filler. The filler comprises or consists of a mineral filler and/or a fibrous material. The base material contains between 3 wt.-% and 60 wt.-% of the wax, and between 40 wt.-% and 97 wt.-% of the filler.

In embodiments of the invention, the base material may contain between 3 wt.-% and 40 wt.-% of the wax, and between 60 wt.-% and 97 wt.-% of the filler. In further embodiments of the invention, the base material may contain between 3 wt.-% and 30 wt.-% of the wax, and between 70 wt.-% and 97 wt.-% of the filler.

According to the invention, it is provided that the molded article comprises a shaping element, the shaping element comprising or consisting of a fiber material.

By combining a wax-based base material with the above-mentioned components with a shaping element, the above-mentioned disadvantages of existing materials can be at least partially overcome. The shaping element may permit a mechanical stiffening of the base material.

Additionally, the shaping element may protect the base material against liquids or harmful substances. The shaping element may also be used for labeling the base material.

It was found that the use of fiber materials permits a particularly reliable bond between the base material and the shaping element.

In particular, this makes it possible to join the base material and the shaping element without a bonding or adhesive layer between the two materials. Without being bound by this theory, it is assumed that the wax mass, which is liquid during the molding process, partially penetrates into the fiber material of the shaping element, thus forming a solid bond.

In this regard, the base materials of the present invention differ from commonly used polymer materials. Waxes typically have a narrowly defined melting point, above which a low viscosity liquid phase is formed. In contrast, polymer materials typically have a comparatively broad melting range and a polymer melt is a highly viscous mass even at temperatures well above this melting range. It is believed that the liquid wax melt can interact much better with the shaping element, thereby creating a stable and durable bond. In particular, the materials, i.e., the base material and the fiber material of the shaping element, can intermingle in a transition layer.

In the context of the present invention, the term “wax” means a mixture of organic compounds or a single organic compound which is solid or kneadable at room temperature and melts at elevated temperatures, in particular above 40° C.

For example, waxes may be aliphatic alcohols (more than 6 carbon atoms, in particular more than 10 carbon atoms), aliphatic carboxylic acids, ketones and long-chain hydrocarbons or a mixture of several of these substances.

Optionally, the wax is part of an organic binder, or the wax is the organic binder. Optionally, the organic binder is a liquid without any solids suspended therein at a temperature between 50° C. and 150° C., preferably between 70° C. and 120° C. Preferably, the organic binder is free of polymers.

The wax may be one or more from the following group: vegetable wax, animal wax, mineral wax, synthetic wax. Examples of vegetable waxes include carnauba wax; candelilla wax; rice wax; castor wax; sunflower wax; sugarcane wax. Examples of animal waxes are wool wax and beeswax. Examples of mineral waxes are paraffin wax and montan wax. An example of a synthetic wax is stearin. Synthetic waxes may also comprise semi-synthetic waxes made from natural products through a chemical conversion step. For example, stearin may be obtained by saponification of vegetable oils. Preferred waxes are vegetable waxes.

The wax may also be a wax obtained from the Fischer-Tropsch process. Thus, the wax may be a Fischer-Tropsch wax. In particular, the wax may be a CO₂ wax or a Fischer-Tropsch CO₂ wax. In particular, this wax can be a by-product from the Fischer-Tropsch process and represents a sustainable alternative to waxes obtained from fossil raw materials that surprisingly have comparable properties. The wax obtained from the Fischer-Tropsch process may optionally be combined with one or more of the other waxes listed above.

Optionally, the fiber material of the shaping element is selected from one or more of: natural fibers, in particular cellulose fibers; synthetic fibers, textile fibers; paper fibers; recycled fibers.

Optionally, the fiber material of the shaping element is or comprises a natural fiber, wherein the natural fiber may selected from one or more of: bagasse; wood; cotton; hemp; flax; kenaf; coconut; pineapple; palm; banana; water hyacinth; sea grass; bamboo; reed; grass; straw; bast; cotton linters; rice husks. Fiber materials made from natural fibers allow a particularly advantageous compostability of the container.

Optionally, the fiber material is a waste material, such as pre-consumer waste, e.g., lyocell fibers or modal fibers.

Optionally, the fiber material of the shaping element is or comprises a synthetic fiber, wherein the fiber may selected from one or more of: viscose; nylon; polyester; aramid; polyethylene.

Optionally, the fiber material of the shaping element is or comprises a paper material. Optionally, the paper material may be selected from one or more of: stone paper; grass paper; bamboo paper. Optionally, the paper material may be pre-printed.

Optionally, the shaping element is a fibrous molded part. In the context of the present invention, a “fibrous molded part” is a molded article produced according to a method known in the art from a fiber mass, such as a fiber slurry. A fibrous molded part may have a geometry adapted to the respective purpose.

The fibrous molded part may contain a fiber material with fibers in any arrangement, such as in paper form, in the form of a fiber netting or as felt or fabric.

Optionally, the base material contains a mineral filler. Preferably, the mineral filler is not water-soluble and/or not soluble in the binder. “Not soluble” or “insoluble” might mean that a substance dissolves in a liquid in a concentration of at most 0.1 wt.-%, preferably at a temperature of about 20° C.

Optionally, the mineral filler is selected from one or more water-insoluble alkali and/or alkaline earth metal compounds. The mineral filler may be produced synthetically or obtained from a natural raw material, such as rocks. A preferred mineral filler is a magnesium or calcium compound, particularly preferably calcium carbonate.

Other usable mineral fillers are unburnt plaster, basalt, pumice, dolomite, glass, garnet, granite, wood ash, kaolin powder, bone ash, marble, meerschaum, quartz, fire clay, whiting, silica, talc, volcanic ash, wollastonite, barium sulfate, bentonite, mica, montmorillonite, barite.

Optionally, the base material contains a fibrous material. Preferably, the fibrous material is not water-soluble and/or not soluble in the binder.

Preferably, the base material may contain between 1 wt.-% and 15 wt.-% of the fibrous material. A more preferable content of the fibrous material is between 1 wt.-% and 7 wt.-%. A fibrous material may be a material with a higher spatial extension in one direction than in the other two directions. A fibrous material may also comprise in particular elongated aggregates with an anisotropy in one spatial direction.

The fibrous material may be one or more from the following group: natural fibers, in particular cellulose fibers, synthetic fibers, textile fibers, paper fibers, recycled fibers. Preferred fibrous materials are natural fibers, such as bagasse, wood, cotton, hemp, flax, kenaf, coconut, pineapple, palm, banana, water hyacinth, sea grass, bamboo, reed, grass, straw, bast, cotton linters, rice husks.

The length of the fibers, in particular their average length, is optionally less than 10 mm, preferably less than 2 mm. Particularly preferably, it is between 100 μm and 1000 μm.

Optionally, the filler/s has/have a melting point of more than 150° C., preferably more than 200° C. This prevents the filler from melting at the usual processing temperatures of the base material. Optionally, certain components of the filler mixture have a decomposition point and no melting point.

In a preferred embodiment, the base material comprises:
50 wt.-% to 85 wt.-% calcium carbonate,
10 wt.-% to 40 wt.-% wax, in particular carnauba wax and/or rice wax, and
1 wt.-% to 5 wt.-% cellulose fibers.

Optionally, the base material is made of at least 95 wt.-%, preferably entirely, natural and/or renewable raw materials.

Optionally, it is provided that the fiber material of the shaping element and the fibrous material of the base material comprise the same fiber component. It was found that this allows for a stable bond to be established between the two components. “The same fiber component” might mean that the fibers are made of the same material, but do not necessarily have the same properties or come from the same raw material. In an example, both the fiber material of the shaping element and the fibrous material of the base material may comprise cellulose fibers. However, these cellulose fibers may have different fiber lengths and are still considered to be “the same fiber component” within the meaning of the present invention. To fall under this definition, the fibers mentioned can come from the same or different raw materials.

One example, where the fiber components do not conform to the definition of “the same fiber component” is when the fiber material of the shaping element is made of cellulose fibers and the fibrous material of the base material is made of viscose fibers. Although this example is not covered by said optional feature, the invention may extend to such a combination in a general definition.

The shaping element may be arranged on the base material as a coating element. In this case, the shaping element is not entirely, in particular only on one side, in contact with the base material. Alternatively, the shaping element may be completely enclosed in the base material.

The shaping element may serve the purposes of a coating element, a labeling element, a support element or the like.

The shaping element and the base material may have at least one common contact surface. In particular, the contact surface may be a direct contact surface so that no additional layer or no additional intermediate element is arranged between the base material and the shaping element.

Surprisingly, this embodiment is made possible by the present invention, and a stable bond can be produced without additional adhesion-promoting layers.

The shaping element may at least partially comprise a sealing layer. This sealing layer may, for example, have one or more of the following properties: water impermeable, air impermeable, water repellent. The sealing layer may be selected from one or more of the following: SiOₓ layer; hybrid polymer layer, in particular organic-inorganic hybrid polymer layer; biopolymer layer, dispersion coating, wax layer, such as from the group of vegetable wax, animal wax, mineral wax, synthetic wax, biomass wax; metal layer; plastic layer. For example, a hybrid polymer layer may be a so called ormocer layer.

The invention further relates to a method for producing a molded article. The method according to the invention comprises the following steps:
providing a shaping element, which comprises or consists of a fibrous material, in a negative mold of the molded article,
introducing a molding material into the negative mold, wherein the molding material contains a wax and a filler mixture, wherein the filler mixture comprises or consists of a mineral filler and a fibrous material, wherein the molding material contains between 3 wt.-% and 60 wt.-% of the wax, and wherein the molding material contains between 40 wt.-% and 97 wt.-% of the mineral filler, and
cooling the molding material for forming the molded article.

Forming the molded article can be done using suitable molding processes. Possible embodiments are one or more of the following: shell casting; injection molding; transfer molding; extrusion; deep-drawing; calendaring; rotational molding; pressure bag molding; compression molding.

In an optional additional method step, a sealing layer may be applied to the shaping element. This may be done either before or after bonding the shaping element to the molding material.

Further features of the invention can be derived from the patent claims, the figures and the description of the exemplary embodiments.

In the following, the present invention is described in detail by means of exemplary embodiments.

In the figures:

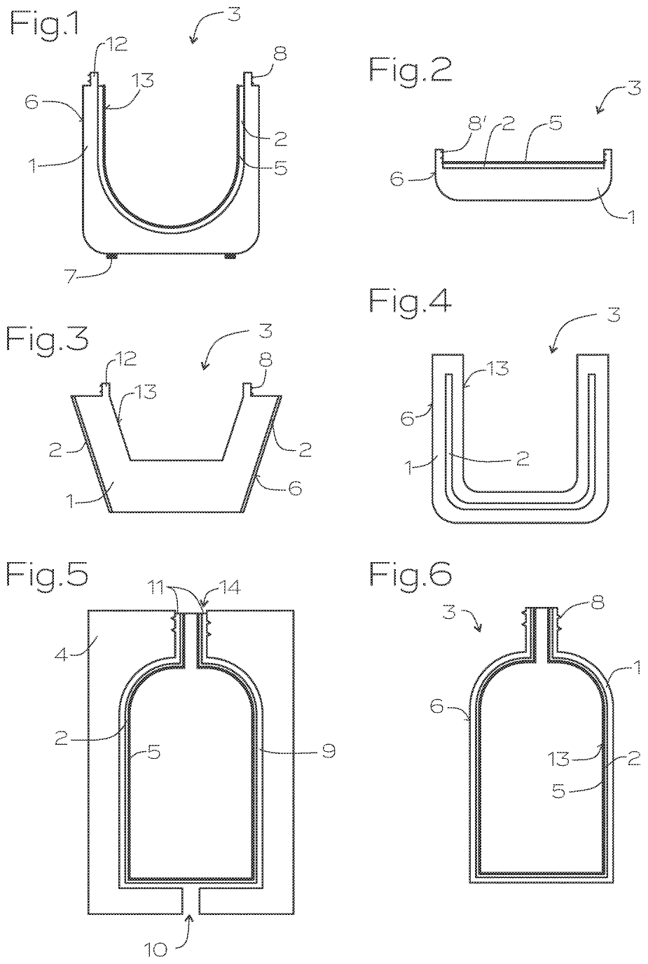

FIG. 1 shows a schematic sectional view of a first exemplary embodiment of an inventive molded article;

FIG. 2 shows a schematic sectional view of a second exemplary embodiment of an inventive molded article;

FIG. 3 shows a schematic sectional view of a third exemplary embodiment of an inventive molded article;

FIG. 4 shows a schematic sectional view of a fourth exemplary embodiment of an inventive molded article;

FIG. 5 shows a schematic sectional view of a negative mold for producing a fifth exemplary embodiment of an inventive molded article; and

FIG. 6 shows a schematic sectional view of a fifth exemplary embodiment of an inventive molded article.

FIG. 1 shows a schematic sectional view of a first exemplary embodiment of an inventive molded article 3. In this embodiment, the molded article 3 is formed as a cream pot. The base material 1 consists of 70 wt.-% calcium carbonate as mineral filler, 5 wt.-% cellulose fibers as fibrous material and 25 wt.-% carnauba wax as wax/organic binder.

A shaping element 2 made of pressed cellulose fibers is arranged on the inside of the molded article 3. The shaping element 2 is in direct contact with the base material 1. A sealing layer 5 of SiO₂, which was applied by a vapor deposition method, is arranged on the opposite surface of the shaping element 2. The inner surface 13 of the molded article 3 is formed by the sealing layer 5.

On its open side, the molded article 3 has a threaded projection 12 with a threaded element 8 arranged thereon. A standing ring 7 is arranged on the opposite closed side of the molded article 3. The outer surface 6 of the molded article 3 is uncoated.

FIG. 2 shows a schematic sectional view of a second exemplary embodiment of an inventive molded article 3. The base material 1 consists of 70 wt.-% calcium carbonate as mineral filler, 5 wt.-% cellulose fibers as fibrous material and 25 wt.-% carnauba wax as wax/organic binder. The molded article 3 is designed as a lid for the cream pot of FIG. 1. Therefore, the molded article 3 has a threaded element 8 that is designed to engage with the threaded element 8 of the molded article 3 of FIG. 1.

A shaping element 2 made of pressed cellulose fibers is arranged as a circular plate on the inside of the molded article 3 of the second embodiment. The shaping element 2 is in direct contact with the base material 1. As in the first exemplary embodiment, the shaping element 2 is coated on its surface with an SiO₂layer as a sealing layer 5. The outer surface 6 of the molded article 3 is uncoated.

When the lid of the second exemplary embodiment is completely screwed onto the cream pot of the first exemplary embodiment, the threaded projection 12 applies a pressure on the shaping element 2 so that a seal effect is obtained.

FIG. 3 shows a schematic sectional view of a third exemplary embodiment of an inventive molded article 3. This molded article 3 is also designed as a cream pot, but with a tapered outer surface. The base material 1 consists of 80 wt.-% calcium carbonate as mineral filler, 3 wt.-% cellulose fibers as fibrous material and 17 wt.-% rice wax as wax/organic binder.

A threaded element 8 is arranged at the open end of the molded article 3 to be able to close the container with a suitable lid. This lid may be similar to the molded article 3 of the second exemplary embodiment in terms of geometry.

In contrast to the above described exemplary embodiments, the inner surface 13 of the molded article 3 of the third exemplary embodiment is uncoated. On the outer surface, a shaping element 2 made of paper is arranged. The shaping element 2 is printed on the visible surface.

FIG. 4 shows a schematic sectional view of a fourth exemplary embodiment of an inventive molded article 3, which is formed as a container. In this exemplary embodiment, a shaping element 2 made of bagasse is surrounded by a base material 1 on all sides. The base material 1 consists of 80 wt.-% calcium carbonate as mineral filler and 20 wt.-% carnauba wax as wax/organic binder. Both the inner surface 13 and the outer surface 6 of the container expose the uncoated base material 1.

FIG. 5 shows a schematic sectional view of a negative mold 4 for producing a fifth exemplary embodiment of an inventive molded article 3. The negative mold 4 is suitable for injection molding. Details are not shown to simplify the view.

The negative mold 4 is designed to be hinged open and has an injection opening 10 into which a molding mass can be introduced. A molding space 9 extends inside the negative mold 4, in which a shaping element 2 made of recycled cardboard is arranged in this view. The shaping element 2 is held in the correct position within the molding space 9 by holding elements 11. The shaping element 2 has a water-impermeable sealing layer 5 of ormocer material (hybrid polymer material) on its inside.

When a molding mass is introduced into the negative mold 4 through the injection opening 10, it penetrates only into the area that is around the shaping element 2. This allows a molded article 3 to be formed as shown in FIG. 6. Excess molding mass can escape via the outlet opening 14.

The molded articles 3 of the exemplary embodiments described above were produced with similar conditions.

The molded article 3 produced in this way is in the form of a bottle. The base material 1 consists of 80 wt.-% calcium carbonate as mineral filler, 3 wt.-% cellulose fibers as fibrous material and 17 wt.-% rice wax as wax/organic binder. This material mixture is not blowable. In order to nevertheless be able to form a hollow body with little process effort, the shaping element 2 is used as a basic mold which remains on the molded article 3 even after demolding. In addition to preserving a cavity, the shaping element 2 also fulfils the other properties of the invention described above.

Thus, the manufactured bottle has a sealing layer 5 of ormocer material on its inner surface 13, and the outer surface 6 is uncoated. On the opening side, a threaded element 8 is provided to enable the bottle to be tightly closed with a screw cap. After demolding, the molded article 3 is cut off above the threaded element 8 to remove the cavities created by the holding elements 11.

### List of Reference Signs

1 Base material
2 Shaping element
3 Molded article
4 Negative mold
5 Sealing layer
6 Outer surface
7 Standing ring
8 Threaded element
9 Molding space
10 Injection opening
11 Holding element
12 Threaded projection
13 Inner surface
14 Outlet opening

1. A molded article, comprising a base material (1), wherein the base material (1) contains a wax and a filler, wherein the filler comprises or consists of a mineral filler and/or a fibrous material,
wherein the base material (1) contains between 3 wt.-% and 60 wt.-% of the wax, and
wherein the base material (1) contains between 4 wt.-% and 97 wt.-% of the filler, characterized in that the molded article (3) comprises a shaping element (2), wherein the shaping element (2) comprises or consists of a fiber material.

2. The molded article according to claim 1, characterized in that the wax is one or more of the following group: vegetable wax, such as carnauba wax; candelilla wax; rice wax; castor wax; sunflower wax; sugarcane wax, animal wax, such as wool wax and beeswax, mineral wax, such as paraffin wax, montan wax, synthetic wax, such as stearin.

3. The molded article according to claim 1, characterized in that the wax is a Fischer-Tropsch wax, in particular a CO₂ wax.

4. The molded article according to claim 1, characterized in that the fiber material of the shaping element (2) is selected from one or more of: natural fibers, in particular cellulose fibers; synthetic fibers, textile fibers; paper fibers; recycled fibers.

5. The molded article according to claim 1, characterized in that the fiber material of the shaping element (2) is or comprises a natural fiber, which is selected from one or more of: bagasse; wood; cotton; hemp; flax; kenaf; coconut; pineapple; palm; banana; water hyacinth; sea grass; bamboo; reed; grass; straw.

6. The molded article according to claim 1, characterized in that the fiber material of the shaping element (2) is or comprises a synthetic fiber, which is selected from one or more of: viscose; nylon; polyester; aramid; polyethylene.

7. The molded article according to claim 1, characterized in that the fiber material of the shaping element (2) is or comprises a paper material, which is optionally selected from one or more of: stone paper; grass paper; bamboo paper.

8. The molded article according to claim 1, characterized in that the fiber material of the shaping element (2) is present as fiber netting, felt or fabric.

9. The molded article according to claim 1, characterized in that the shaping element (2) is or comprises a fibrous molded part.

10. The molded article according to claim 1, characterized in that the fiber material of the shaping element (2) and the fibrous material of the base material (1) comprise the same fiber component.

11. The molded article according to claim 1, characterized in that the shaping element (2) has a sealing layer (5) on its surface.

12. The molded article according to claim 11, characterized in that the sealing layer (5) is selected from one or more of the following: SiOₓ layer; hybrid polymer layer, in particular organic-inorganic hybrid polymer layer; biopolymer layer; dispersion coating; wax layer, such as vegetable wax, animal wax, mineral wax, synthetic wax, biomass wax; metal layer; plastic layer.

13. The molded article according to claim 1, characterized in that the shaping element (2) has a decorative element on its surface, optionally on the sealing layer (5), which is not meltable at the melting temperature of the molded article (3).

14. A method for producing a molded article (3), comprising the steps of:
providing a shaping element (2), which comprises or consists of a fiber material, in a negative mold (4) of the molded article (3),
introducing a molding material into the negative mold (4), wherein the molding material contains a wax and a filler, wherein the filler comprises or consists of a mineral filler and/or a fiber, wherein the molding material contains between 3 wt.-% and 60 wt.-% of the wax, and wherein the molding material contains between 40 wt.-% and 97 wt.-% of the filler, and
cooling the molding material for forming the molded article (3).

15. The method according to claim 14, characterized in that the introduction of the molding material is done by one or more of: shell casting; injection molding; transfer molding; extrusion; deep-drawing; calendering; rotational molding; pressure bag molding; compression molding.

16. The method according to claim 14, characterized in that the method additionally comprises:
applying a sealing layer (5) to the shaping element (2).
